(19) United States
(12) Patent Application Publication
(10) Pub. No.: US 2015/0223465 A1
(43) Pub. Date: Aug. 13, 2015

(54) COMPOSITION CONTAINING 3-CYCLOPROPYL-1-ENYL-PROPANOIC ACID SALTS AND A CARRIER

(71) Applicant: Yissum Research Development Company of the Hebrew University of Jerusalem Ltd., Jerusalem (IL)

(72) Inventors: Raphael Goren, Rechovot (IL); Moshe Huberman, Rechovot (IL); Eliezer Goldschmidt, Rechovot (IL); Joseph Riov, Petach-Tikva (IL); Akiva Apelbaum, Rechovot (IL)

(73) Assignee: Yissum Research Development Company of the Hebrew University of Jerusalem Ltd.

(21) Appl. No.: 14/425,345

(22) PCT Filed: Sep. 3, 2013
(86) PCT No.: PCT/IL2013/050750

§ 371 Date: Mar. 3, 2015

Related U.S. Application Data
(60) Provisional application No. 61/697,187, filed on Sep. 5, 2012.

(51) Int. Cl. A01N 53/00; A01N 3/02; A01N 59/26; A01N 25/02; A01N 59/04

(52) U.S. Cl. CPC A01N 53/00; A01N 25/02; A01N 59/04; A01N 59/26; A01N 3/02

(57) ABSTRACT

An aqueous composition containing a water soluble cyclopropyl-1-enyl-propanoic acid salt (CPAS) of formula (I) as described in the specification and a bicarbonate-containing solution is disclosed. Further disclosed are kits for producing or providing the composition and methods utilizing the composition for antagonizing ethylene action in a plant and/or delaying senescence of a cut plant.

### FIELD AND BACKGROUND OF THE INVENTION

The present invention, in some embodiments thereof, relates to compositions for regulating plant growth, and, more particularly, but not exclusively, to aqueous compositions containing a water soluble 3-cyclopropyl-1-enyl-propanoic acid salt (“CPAS”) and to uses thereof in antagonizing ethylene response in plants and in delaying senescence of cut plants, e.g., cut flowers.

The hormone ethylene regulates physiological responses in plants (see Abeles et al., Ethylene in Plant Biology, Academic Press, 2nd ed., 1992). Ethylene is produced in all higher plants and is usually associated with stimulation of fruit ripening, leaf and fruit abscission, flower opening, and flower and leaf senescence. Ethylene antagonists (EAs) antagonize the action of ethylene, and thus find many applications in agriculture and horticulture, e.g., in the prevention of pre-ripening fruit drop and extending fruit shelf life.

The known ethylene antagonists include cyclopropene derivatives. For example, 1-methyl-cyclopropene (“1-MCP”) has been very popular in the past 18 years for post-harvest handling to prolong fruit shelf life, or to delay senescence of leafy vegetables and cut flowers. However, because 1-MCP is a volatile gas, it has to be used in an enclosed environment only.

In a search for non-volatile, preferably water-soluble, cyclopropene derivatives, Grichko, V. [Russian Journal of Plant Physiology 53(4):523-529 (2006)] has synthesized some water soluble carboxylic acid derivatives of cyclopropene, including cycloprop-2-ene-1-carboxylic acid, 2-methylcycloprop-2-ene-1-carboxylic acid, and 3-cycloprop-1-en-1-ylpropanoic acid, and tested their activity as plant ethylene antagonists. Grichko uncovered that the water soluble carboxylic acid derivatives of cyclopropene, while being active in a vapor phase, did not inhibit the action of ethylene when applied as aqueous solutions to cut mini carnation flowers. Additionally, Grichko uncovered that one carboxylic acid salt derivative of cyclopropene, propan-2-aminium 3-cycloprop-1-en-1-ylpropanoate, when applied as an aqueous solution, showed some ethylene sensitivity but the test results were variable (see id.). Grichko concluded that the development of a potent water soluble cyclopropene derived ethylene antagonist has not been easy (see id.)

WO 2009/010981 discloses water soluble cyclopropyl-1-enyl-propanoic acid salts (CPASs), including cyclopropyl-1-enyl-propanoic sodium salt, and a process of making same. WO 2009/010981 discloses utilizing the water solubility of CPASs for applying it to harvested plants, mainly by spraying. See also Goren et al., Plant Growth Regulation 65:327-334 (2011).

WO 2010/082203 discloses a method of inhibiting an ethylene response in a field crop, by applying an effective amount of CPAS to at least one portion of the field crop in the field, e.g., in milky stages I and II of wheat plants.

WO 2011/086561 discloses a process of preparing highly pure powder 3-(1-cyclopropyl) propenoic acid, that was further converted as 3-(1-cyclopropyl) propenoic acid sodium salt.

WO 2009/010981, WO 2010/082203, and WO 2011/086561 are each incorporated by reference as if fully set forth herein.

Meeteren et al., Postharvest Biology and Technology 17(3): 175-187 (1999), studied the use of deionized water (“DI water”) as vase water in postharvest experiments on cut flowers, and reported that sodium bicarbonate (NaHCO₃) had no effect on hydraulic stem resistance or transpiration rate of the tested cut flowers. However, at about 1.5 mM concentration, NaHCO₃ positively affected the fresh weight of the cut flowers during vase life when combined with CuSO₄.

### SUMMARY OF THE INVENTION

While water soluble cyclopropyl-1-enyl-propanoic acid salts have been successfully utilized heretofore in antagonizing ethylene response when applied as an aqueous solution to harvested plants by spraying, and when applied to field crops, their use in antagonizing ethylene response when directly applied to cut plants (e.g., cut flowers), has been limited by non-reproducible and/or insufficient water uptake.

The present inventors have designed and successfully practiced a novel composition containing a water-soluble cyclopropyl-1-enyl-propanoic acid salt (CPAS) of formula (I) as described herein, in a carrier that comprises a bicarbonate-containing aqueous solution, which improves the uptake of CPAS in cut plants or intact plants, thereby improving the efficacy of CPAS when applied directly to cut plants or intact plants. The successful performance of the disclosed composition is surprising and unexpected in view of the state of art.

According to an aspect of some embodiments of the present invention there is provided a composition comprising a water-soluble cyclopropyl-1-enyl-propanoic acid salt of formula (I):

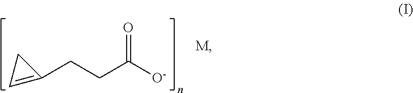

wherein:
n is 1 or 2, and
M is a monovalent or divalent cation, respectively
and
a bicarbonate-containing aqueous solution.

According to some embodiments of the present invention, the bicarbonate solution comprises a bicarbonate salt.

According to some embodiments of the present invention, the bicarbonate salt is selected from NaHCO₃ and KHCO₃.

According to some embodiments of the present invention, the bicarbonate solution comprises NaHCO₃.

According to some embodiments of the present invention, the bicarbonate solution further comprises sodium-containing buffer.

According to some embodiments of the present invention, the buffer is selected from sodium phosphate buffer, sodium citrate buffer and a combination thereof.

According to some embodiments of the present invention, an amount of the sodium-containing buffer is such that a pH of the composition is at least 6.5.

According to some embodiments of the present invention, the bicarbonate-containing solution comprises a carbonate/bicarbonate buffer.

According to some embodiments of the present invention, the buffer is a sodium carbonate/sodium bicarbonate buffer.

According to some embodiments of the present invention, a pH of the buffer is higher than 9.0.

According to some embodiments of the present invention, a pH of the bicarbonate-containing solution is higher than 7.0.

According to some embodiments of the present invention, a pH of the bicarbonate-containing solution is higher than 8.0.

According to some embodiments of the present invention, a concentration of the water soluble cyclopropyl-1-enyl-propanoic acid salt ranges from about 10 ppm to about 200 ppm.

According to some embodiments of the present invention, a concentration of the water soluble cyclopropyl-1-enyl-propanoic acid salt ranges from about 20 to about 160 ppm.

According to some embodiments of the present invention, a concentration of the water soluble cyclopropyl-1-enyl-propanoic acid salt ranges from about 40 to about 120 ppm.

According to some embodiments of the present invention, the composition comprises from about 20 to about 160 ppm of the water-soluble cyclopropyl-1-enyl-propanoic acid salt of formula (I); a an aqueous solution comprising a bicarbonate in a concentration of from about 20 mM to about 160 mM; and water.

According to some embodiments of the present invention, a concentration of the bicarbonate is from about 40 mM to about 80 mM.

According to some embodiments of the present invention, the bicarbonate-containing solution comprises a carbonate/bicarbonate buffer.

According to some embodiments of the present invention, the bicarbonate-containing solution comprises sodium bicarbonate.

According to some embodiments of the present invention, the bicarbonate-containing solution further comprises sodium phosphate, or a combination of sodium phosphate and sodium citrate buffers in a concentration of from about 10 mM to about 80 mM.

According to some embodiments of the present invention, a composition as described herein further comprises an acceptable additive selected from the group consisting of a surfactant, a bactericide, a disinfectant, and a combination thereof.

According to an aspect of some embodiments of the present invention there is provided a method of antagonizing ethylene response in a plant, the method comprising contacting at least a part of the plant with a composition as described herein.

According to some embodiments of the present invention, the plant is an ornamental plant, a pot plant, a flower, a vegetable, a fruit or a field crop.

According to some embodiments of the present invention, the contacting is effected by dipping, loading, immersing, soaking, brushing, spraying, and/or irrigating.

According to some embodiments of the present invention, the contacting is carried out after the plant is picked, cut or harvested.

According to some embodiments of the present invention, the applying is carried out before the plant is harvested, during its growing stage and/or at its growing site.

According to an aspect of some embodiments of the present invention there is provided a method of delaying senescence of a cut plant, the method comprising contacting at least a part of the cut plant with a composition as described herein.

According to some embodiments of the present invention, the cut plant is a cut flower.

According to some embodiments of the present invention, the contacting comprises dipping, loading, immersing, soaking, brushing, spraying, and/or irrigating.

According to some embodiments of the present invention, the contacting is carried out by loading.

According to an aspect of some embodiments of the present invention there is provided a kit for forming and/or providing the composition as described herein, the kit comprising the CPAS, and the bicarbonate-containing solution.

According to some embodiments of the present invention, the CPAS and the bicarbonate-containing solution are packaged individually within the kit.

According to some embodiments of the present invention, the CPAS is in a dry form.

According to some embodiments of the present invention, the CPAS is in a form selected from a powder, granules, or particulate.

According to some embodiments of the present invention, the CPAS is dissolved is an aqueous carrier.

According to some embodiments of the present invention, the kit comprises a concentrated solution of the CPAS.

According to some embodiments of the present invention, the CPAS and the bicarbonate-containing solution are packaged together within the kit, in a form of a concentrate or a paste or formulated as described herein.

According to some embodiments of the present invention, the kit further comprises an aqueous carrier.

According to some embodiments of the present invention, the kit further comprises instructions to mix the CPAS and the bicarbonate-containing solution, with an aqueous carrier.

According to some embodiments of the present invention, any of the kits described herein is identified for use in antagonizing ethylene response in a plant and/or in delaying senescence of a cut plant.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-B present photographs of cut carnations (36 cm long stems) treated, by loading for 24 hours, with aqueous solutions containing CPAS (sodium salt; 0, 60 or 120 ppm) in Na₂CO₃/NaHCO₃ buffer (20 mM, pH 9.4) (FIG. 1A), and aqueous solutions containing CPAS in NaHCO₃ (20 mM, pH 8.2) (FIG. 1B), followed by exposure to air or 2 ppm ethylene for 24 hours; photographs taken after five days in tap water following ethylene treatment.

FIG. 2 presents bar graphs illustrating water uptake of CPAS (sodium salt) in cut carnations (36 cm long stems) treated with aqueous solutions containing CPAS (sodium salt; 0, 60 or 120 ppm) NaHCO₃ (20 mM, pH 8.2), after loading for 24 hours (FIG. 2A), and 48 hours after exposure to air or 2 ppm ethylene for 24 hours terminated.

FIGS. 3A-C present photographs of cut carnations having stem lengths of 15 cm (FIG. 3A), 36 cm (FIG. 3B) and 55 cm (FIG. 3C), treated, by loading for 24 hours, with aqueous solutions containing CPAS (sodium salt; 0, 60 or 120 ppm) in NaHCO₃ (20 mM, pH 8.2), followed by exposure to air or 2 ppm ethylene for 24 hours; photographs taken after five days in tap water following ethylene treatment.

FIGS. 4A-B present photographs of cut carnations (55 cm long stems) treated, by loading for 24 hours, with aqueous solutions containing CPAS (sodium salt; 0, 60 or 120 ppm) in Na₂CO₃/NaHCO₃ buffer (20 mM, pH 9.4) (FIG. 4A), and aqueous solutions containing CPAS in NaHCO₃ (20 mM, pH 8.2) (FIG. 4B), followed by exposure to air or 2 ppm ethylene for 24 hours; photographs taken after five days in tap water following ethylene treatment.

FIG. 5 presents a bar graph illustrating the senescence delaying effect of CPAS (sodium salt) in a solution containing 40, 60 and 80 mM Na₂CO₃/NaHCO₃ buffer, on cut carnations (55 cm long stems), after treatment, by loading for 24 hours, followed by exposure to air or 2 ppm ethylene for 24 hours, as measured by lower diameter after five days in tap water following ethylene treatment.

FIG. 6 presents a bar graph illustrating the senescence delaying effect of CPAS (sodium salt) in a solution containing 40, 60 and 80 mM NaHCO₃ solutions, on cut carnations (55 cm long stems), after treatment, by loading for 24 hours, followed by exposure to air or 2 ppm ethylene for 24 hours, as measured by lower diameter after five days in tap water following ethylene treatment.

FIG. 7 presents photographs of cut carnations (36 cm long stems) treated, by loading for 24 hours, with aqueous solutions containing CPAS (sodium salt) in Na-phosphate buffer containing NaHCO₃ (60 mM), followed by exposure to air or 2 ppm ethylene for 24 hours; photographs taken after five days in tap water following ethylene treatment.

FIGS. 8A-B present bar graphs illustrating the effect of CPAS (sodium salt) in a solution of Na-phosphate buffer (20 mM) containing 60 mM or 80 NaHCO₃ (FIG. 8A) and in a solution of Na-phosphate/citrate buffer (20 mM) containing 60 mM or 80 NaHCO₃ on cut carnations (55 cm long stems), after treatment, by loading for 24 hours, followed by exposure to air or 2 ppm ethylene for 24 hours, as measured by lower diameter after five days in tap water following ethylene treatment.

FIG. 9 presents photographs of cut carnations sprayed with aqueous solutions containing CPAS (sodium salt; 0, 40, 80 or 120 ppm) dissolved in a solution of Na₂CO₃/NaHCO₃ buffer (60 mM, pH 9.2) and Triton-X 100™ (0.05%) in DI water, taken following three days in tap water after exposure for 24 hours to air or ethylene.

FIG. 10 presents a bar graph illustrating the effect of spraying cut carnations sprayed with aqueous solutions containing CPAS (sodium salt; 0, 40, 80 or 120 ppm) dissolved in a solution of Na₂CO₃/NaHCO₃ buffer (60 mM, pH 9.2) and Triton-X 100™ (0.05%) in DI water, as measured by flower diameter, following three days in tap water after exposure for 24 hours to air or ethylene.

FIG. 11 presents photographs of cut carnations sprayed with aqueous solutions containing CPAS (sodium salt; 0, 40, 80 or 120 ppm) dissolved in a solution containing NaHCO₃ (40 mM, pH 8.2) and Kinetic® (0.05%) in tap water, taken following three days in tap water after exposure for 24 hours to air or ethylene.

FIG. 12 presents a bar graph illustrating the effect of spraying cut carnations with aqueous solutions containing CPAS (sodium salt; 0, 40, 80 or 120 ppm) dissolved in NaHCO₃ buffer (40 mM, pH 8.2) and Kinetic® (0.05%) in tap water, as measured by flower diameter, following three days in tap water after exposure for 24 hours to air or ethylene.

FIGS. 13A-B present photographs of cut carnations (36 and 50 cm long stems) treated, by loading for 14-18 hours, with a composition containing CPAS (sodium salt) in Na-Carbonate buffer (FIG. 13A) or in K-phosphate buffer (FIG. 13B), followed by immediate exposure to air or 1.0 ppm ethylene for 24 hours, and then immersion in tap water; photographs taken 13 days from the beginning of the experiment.

FIGS. 14A-B present photographs of cut carnations (36 cm long stems) treated, by loading for 14-18 hours, with a composition containing CPAS (sodium salt) in Na-Carbonate buffer (FIG. 14A) or in K-phosphate buffer (FIG. 14B), followed by exposure to air for 24 hours and then exposure to air or 1.0 ppm ethylene for 24 hours, and then immersion in tap water; photographs taken 13 days from the beginning of the experiment.

FIGS. 15A-B present photographs of cut carnations (36 cm long stems) treated, by loading for 14-18 hours, with a composition containing CPAS (sodium salt) in Na-Carbonate buffer (FIG. 15A) or in K-phosphate buffer (FIG. 15B), followed by exposure to air for 48 hours and then exposure to air or 1.0 ppm ethylene for 24 hours, and then immersion in tap water; photographs taken 13 days from the beginning of the experiment.

FIGS. 16A-B present photographs of cut carnations (36 cm long stems) treated, by loading for 14-18 hours, with a composition containing CPAS (sodium salt) in Na-Carbonate buffer (FIG. 16A) or in K-phosphate buffer (FIG. 16B), followed by exposure to air for 24 hours and then exposure to air or 1.0 ppm ethylene for 72 hours, and then immersion in tap water; photographs taken 13 days from the beginning of the experiment.

### DESCRIPTION OF SPECIFIC EMBODIMENTS OF THE INVENTION

The present invention, in some embodiments thereof, relates to compositions for regulating plant growth, and, more particularly, but not exclusively, to aqueous compositions containing a water-soluble 3-cyclopropyl-1-enyl-propanoic acid salt (“CPAS”) and to uses thereof in antagonizing ethylene response in plants and in delaying senescence of cut plants, e.g., cut flowers.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

In a search for compositions of water soluble 3-cyclopropyl-1-enyl-propanoic acid salt (“CPAS”) with improved water uptake when directly applied to cut plants, the present inventors have tested various aqueous compositions containing CPAS and various aqueous carriers, and have uncovered that compositions which contain bicarbonate substantially improve the ethylene response antagonizing activity of CPAS when directly applied to cut plants by, e.g., dipping the cut plant in the composition (so as to effect loading of the composition into the plant).

The present inventors have uncovered that out of a myriad of aqueous carriers which were tested within a CPAS aqueous composition, only compositions with carriers containing bicarbonate, either per se, in combination with a sodium buffer or as part of a bicarbonate/carbonate buffer, exhibited ethylene response antagonizing effect and were demonstrated to successfully delay senescence of cut flowers. These compositions were also shown to exhibit an effect when used with flowers of long stems (e.g., at least 50 cm long stems), and at a range of CPAS concentration and bicarbonate concentrations. These compositions therefore provide a solution to the limited and/or non-reproducible performance of aqueous solutions of CPASs when used, for example, for cut flowers or plants.

It is to be noted in this regard that CPAS-containing aqueous solutions have been previously reported to exhibit exceptional performance in antagonizing ethylene response when applied to various plants, including harvested plants and field crops, by spraying or irrigating, yet, their use for treating, for example, cut flowers or plants, upon dipping or immersing therein, was found to be limited by the uptake of the CPAS by the flower or plant.

Embodiments of the present invention are therefore particularly useful in applications where uptake of the CPAS through the vascular system of the plant is required, as in the case of, for example, cut flowers.

According to an aspect of some embodiments of the present invention, there is provided a composition comprising a water soluble cyclopropyl-1-enyl-propanoic acid salt (CPAS) and a bicarbonate-containing aqueous solution.

In some embodiments, the water soluble cyclopropyl-1-enyl-propanoic acid salt is in a dry form such as powder, granules or any particulate form that dissolves in an aqueous carrier (e.g., water).

In some of these embodiments, the water soluble cyclopropyl-1-enyl-propanoic acid salt dissolves in the bicarbonate-containing aqueous solution.

For the purpose of the present disclosure, the term “water soluble” as used herein refers to a substance exhibiting solubility or miscibility in aqueous solution or carrier.

In some of any of the embodiments described herein, the water soluble cyclopropyl-1-enyl-propanoic acid salt (CPAS) is represented by formula (I):

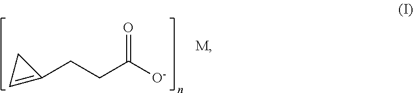

wherein:

n is 1 or 2, and

M is a monovalent or divalent cation,

and

a bicarbonate-containing solution.

In some of any of the embodiments described herein for a CPAS, n is 1, and M is a monovalent cation. Exemplary suitable monovalent cations include, but are not limited to, lithium ion, sodium ion, potassium ion, and any other monovalent ions of metals (including transition metals), ammonium ion, phosphonium ion and sulfonium ion, and any other monovalent inorganic cation.

When n is 2, M is a divalent cation. Exemplary suitable divalent cations include, but are not limited to, calcium ion, magnesium ion, and any other divalent ions of metals, including transition metals.

In some of any of the embodiments described herein for CPAS, n is 1, and M is sodium ion.

In some of any of the embodiments described herein for CPAS, n is 2, and M⁺ is calcium ion.

In some of any of the embodiments described herein, the amount of the water soluble cyclopropyl-1-enyl-propanoic acid salt in the composition ranges from 10 ppm to 200 ppm, or from 20 to about 160 ppm, preferably from about 20 to about 120 ppm, or from about 40 to about 120 ppm. In some of these embodiments, the amount of the water-soluble CPAS is, for example, 20 ppm, 40 ppm, 60 ppm, 80 ppm, 100 ppm or 120 ppm, including any intermediate value.

The term “ppm” as used herein refers to parts per million and is equivalent, for example, to mg of the compound to 1 liter of the composition, or to microgram of the compound in 1 ml of the composition.

As used herein and recognized in the art, a “bicarbonate” refers to a HCO₃-moiety. In some of any of the embodiments described herein, a “bicarbonate” encompasses a bicarbonate salt, namely, HCO₃M, wherein M is a monovalent cation as described herein.

In some of any of the embodiments described herein, a bicarbonate-containing solution comprises a bicarbonate salt.

In some of any of the embodiments described herein, a “bicarbonate” is, for example, sodium bicarbonate (NaHCO₃) or potassium bicarbonate (KHCO₃).

In some of these embodiments, the bicarbonate solution comprises a bicarbonate salt (e.g., sodium bicarbonate (NaHCO₃) or potassium bicarbonate (KHCO₃)) at a concentration of from about 10 mM to about 100 mM, or from about 20 to about 100 mM, or from about 20 to about 80 mM, or from about 20 to about 60 mM, or from about 40 to about 60 mM, or from about 40 to about 80 mM.

In some embodiments, the bicarbonate solution is about 40 mM NaHCO₃ solution.

In one embodiment, the bicarbonate solution is a NaHCO₃ solution. The concentration of NaHCO₃ may range from about 20 to about 80 mM, from about 20 to about 60 mM, from about 20 to about 40 mM, from about 40 to about 60 mM, or from about 40 to about 80 mM. In one embodiment, the bicarbonate solution is about 40 mM NaHCO₃ solution, having a pH value of about 8.2.

The term “mM” as used herein throughout refers to millimolar (mmole/L).

In one embodiment, the bicarbonate solution is a KHCO₃ solution. The concentration of KHCO₃ may range from about 20 to about 80 mM, from about 20 to about 60 mM, from about 20 to about 40 mM, from about 40 to about 60 mM, or from about 40 to about 80 mM.

In some embodiments, aqueous solutions containing a bicarbonate salt are such that feature a pH value higher than 7.0, or higher than 7.5, or higher than 8.0, for example, a pH value of about 8.2.

In some embodiments, the bicarbonate-containing solution comprises, in addition to the bicarbonate, a buffer.

In some embodiments, the buffer is a sodium-containing buffer, for example, a sodium phosphate buffer and/or a sodium citrate buffer.

The concentration of Na-phosphate may range from about 10 to about 80 mM, from about 10 to about 50 mM, or from about 10 to about 30 mM. In one embodiment, the bicarbonate solution further contains about 20 mM Na-phosphate buffer.

In one embodiment, the bicarbonate solution further comprises a sodium phosphate buffer and a sodium citrate buffer (“Na-phosphate/citrate” buffer). The concentration of Na-phosphate/citrate buffer may range from about 10 to about 80 mM, from about 10 to about 50 mM, or from about 10 to about 30 mM. In one embodiment, the bicarbonate solution further contains about 20 mM Na-phosphate/citrate buffer.

In some embodiments, when a bicarbonate-containing solution further comprises a buffer, the pH of the buffer, the concentration of the buffer and the concentration of the bicarbonate salt are such that the aqueous solution features a pH value of at least 7.0. Exemplary such solutions are described in the Examples section that follows.

In some embodiments, which are presently the most preferred embodiments, the bicarbonate-containing solution comprises a carbonate/bicarbonate buffer, which is also referred to herein interchangeably as “a carbonate buffer” and as “a bicarbonate-containing buffer”.

For the purpose of the present disclosure, the term “a carbonate buffer” or “a carbonate/bicarbonate buffer”, as used herein, refers to an aqueous buffer solution comprising at least one carbonate (CO₃⁻²) and at least one bicarbonate, as described herein. In some embodiments, the carbonate buffer comprises at least one carbonate salt (e.g., Na₂CO₃ or K₂CO₃) in water, and at least one bicarbonate salt (e.g., NaHCO₃ or KHCO₃) in water. In one embodiment, the carbonate buffer is a Na₂CO₃/NaHCO₃ buffer.

The concentration of the carbonate buffer (e.g., of the Na₂CO₃/NaHCO₃ buffer) may range from about 10 to about 100 mM, from about 20 to about 100 mM, from about 20 to about 80 mM, from about 20 to about 60 mM, from about 20 to about 40 mM, from about 40 to about 60 mM, or from about 40 to about 80 mM, in the aqueous solution. In one embodiment, the concentration of Na₂CO₃/NaHCO₃ is about 40 mM, having a pH value between about 9.2 and about 9.4.

In some embodiments related to the carbonate buffer, the buffer is such that exhibits a pH value of at least 7.0, at least 8.0 and even at least 9.0.

Table 2 in the Examples section that follows describes the different efficacies of Na₂CO₃/NaHCO₃ buffer and of a NaHCO₃ or KHCO₃ solutions, particularly when compared to other, non-bicarbonate carriers and buffers of different pH values.

In some of any of the embodiments described herein, the bicarbonate-containing solution has a high pH value. For the purpose of the present disclosure, the term “high pH value” as used herein refers to a pH value of higher than 7.0, higher than 7.5, greater than 8.0, higher than 8.5, or higher than 9.0.

In some of any of the embodiments described herein, the bicarbonate-containing solution has a pH value of between about 7.2 and about 9.4, preferably between about 8.2 and about 9.4.

In some of any of the embodiments described herein, the composition as described herein has a pH value between about 7.2 and about 9.4, preferably between about 8.2 and about 9.4.

In some of any of the embodiments described herein, the composition further comprises one or more additives. In some embodiments, the one or more additives are acceptable additives, e.g., agricultural acceptable additives and/or additives acceptable in the context of cut plants. Exemplary additives include, but are not limited to, a surfactant, a bactericide, a disinfectant and any combination thereof.

Suitable surfactants include, but are not limited to, polyalkyleneoxide fatty acid esters, polyalkyleneoxide fatty alcohol ethers, organosilicones and combinations thereof, such as polysorbate surfactants (Tween 20™), a blend of polyalkyleneoxide modified polydimethylsiloxane surfactant (Kinetic®), or toctylphenoxypolyethoxyethanol (Triton-X 100™). Other acceptable surfactants are also contemplated. In an exemplary embodiment, the surfactant is Kinetic®. In another exemplary embodiment, the surfactant is Triton-X 100™.

Suitable bactericides include, but are not limited to, bronopol, dichlorophen, nitrapyrin, nickel dimethyl dithiocarbamate, kasugamycin, octhilinone, furan-carboxylic acid, oxytetracyclin, probenazole, streptomycin, tecloftalam. Other acceptable bactericides are also contemplated. In one embodiment, the aqueous composition of the present invention comprises a bactericide that is chloramphenicol.

Suitable disinfectants include, but are not limited to, household cleaners and chlorine bleach, such as Clorox®. Other disinfectants are also contemplated.

The exceptional performance of the compositions as described herein on exemplary cut plants (cur flowers) upon loading of the composition (e.g., by dipping the cut plant in the composition) is described in the Examples section that follows, and is indicative of the improved uptake of an aqueous composition of CPAS when containing a bicarbonate, as described herein.

According to an aspect of some embodiments of the present invention there is provided a method of antagonizing ethylene response in a plant. The method comprises applying to at least one part of the plant any of the compositions described herein. Herein, “applying to at least one part of the plant a composition” is used interchangeably with “contacting at least one part of the plant with a composition”.

In some of any of the embodiments described herein, the applying or contacting can be effected by any one of, or by a combination of any of, dipping, loading, immersing, soaking, brushing, spraying, and irrigating. The applying can be carried out after the plant has been picked, cut or harvested. The applying can also be carried out before the plant is harvested, during its growing stage and/or at its growing site.

In some of any of the embodiments described herein, the applying or contacting is effected by loading (e.g., by pulsing), dipping, immersing or soaking.

In some of any of the embodiments described herein, the applying or contacting is carried out after the plant has been picked, cut or harvested.

In some embodiments, the applying or contacting is carried out after the plant has been picked, cut or harvested, and is effected by loading (e.g., by pulsing), dipping, immersing or soaking.

Plants to be treated include whole plants and any parts thereof, e.g., leaves, flowers or stems. The term “plant” as used herein is a generic term, and includes ornamental plants, pot plants, flowers, vegetables, fruits and field crops.

Exemplary ornamental plants and flowers include, but are not limited to, azalea (Rhododendron spp.), hydrangea (Macrophylla hydrangea), hybiscus (Hibiscus rosasanensis), snapdragons (Antirrhinum sp.), poinsettia (Euphorbia pulcherima), cactus (e.g. Cactaceae schlumbergera truncata), begonias (Begonia sp.), roses (Rosa spp.), tulips (Tulipa sp.), daffodils (Narcissus spp.), petunias (Petunia hybrida), carnation (Dianthus caryophyllus), lily (e.g., Lilium sp.), gladiolus (Gladiolus sp.), alstroemeria (Alstoemeria brasiliensis), anemone (e.g., Anemone blanda), columbine (Aquilegia sp.), aralia (e.g., Aralia chinensis), aster (e.g., Aster carolinianus), bougainvillea (Bougainvillea sp.), camellia (Camellia sp.), bellflower (Campanula sp.), cockscomb (celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae and other commercial cultivars, hybrids and new developed cultivars.

Exemplary field crops include, but are not limited to: (a) cereal and grain crops, such as wheat, oats, barley, rye, rice, maize, or grain sorghum; (b) legumes for seeds, such as peanut, field pea, cowpea, soybean, lima bean, mung bean chick pea, pigeon pea, broad bean or lentil; (c) forage crops, such as grasses, legumes, crucifers, other crops cultured and used for hay, pasture, fodder, silage or soilage; (d) root crops, such as sweet potato or cassava; (e) fiber crops, such as cotton, flax, ramie, kenaf or hemp; (f) tuber crops, such as potato; (g) sugar crops, such as sugar beet or sugar cane; (h) drug crops, such as tobacco; and (i) oil crops, such as rapeseed, canola, sunflower, safflower, sesame, linseed, castor bean, or perilla.

Additional plants include, but are not limited to, leafy green vegetables such as lettuce (e.g., Lactuea sativa), spinach (Spinaca oleracea), and cabbage (Brassica oleracea), various roots, such as potatoes (Solanum tuberosum) and carrots (Daucus), bulbs, such as onions (Allium sp.), herbs, such as basil (Ocimum basilicum), oregano (Origanum vulgare), dill (Anethum graveolens), as well as soybean (Glycine max), lima beans (Phaseolus limensis), peas (Lathyrus spp.), corn (Zea mays), broccoli (Brassica oleracea italica), cauliflower (Brassica oleracea botrytis), and asparagus (Asparagus officinalis).

The method as described herein can be used to antagonize numerous different ethylene responses. Ethylene responses may be initiated by either exogenous or endogenous sources of ethylene. Ethylene responses include, for example, the ripening and/or senescence of flowers, fruits and vegetables, abscission of foliage, flowers and fruit, the prolongation of the life of ornamentals such as potted plants, cut flowers, shrubbery, and dormant seedlings, in some plants (e.g., pea) the inhibition of growth, and in other plants (e.g., rice) the stimulation of growth.

In some of any of the embodiments described herein, the activity of the composition as described herein in antagonizing ethylene response is particularly advantageous for delaying senescence of cut plants. The compositions described herein were shown to exhibit exceptional activity when contacted per se (namely, not by spraying or irrigation) with cut plants.

It is to be noted that cut plants, upon being cut, picked or harvested, cannot be treated by, for example, irrigation. Cut plants are typically maintained in aqueous solutions and hence an effective uptake of the CPAS by the vascular system (e.g., stems) of the cut plant, upon dipping in aqueous solution, is required.

According to an aspect of some embodiments of the present invention, there is provided a method of delaying senescence of a cut plant. The method comprises applying to (or contacting with, as described herein) at least one part of the cut plant any of the compositions described herein.

In some embodiments, the cut plant includes, without limitation, cut flower, cut shrub or cut leafy vegetable.

In some embodiments, the cut plant has a stem or any other part of the plant's vascular system, which can be dipped in a solution. In some embodiments, the stem can be at least 20 cm, at least 30 cm, at least 40 cm and even at least 50 cm long.

Potted ornamentals and cut flowers which may be treated with the present invention include azalea (Rhododendron spp.), hydrangea (Macrophylla hydrangea) hybiscus (Hibiscus rosasanensis), snapdragons (Antirrhinum sp.), poinsettia (Euphorbia pulcherima), begonias (Begonia sp.), roses (Rosa spp.), tulips (Tulipa sp.), daffodils (Narcissus spp.), petunias (Petunia hybrida), carnation (Dianthus caryophyllus), lily (e.g., Lilium sp.), gladiolus (Gladiolus sp.), alstroemeria (Alstoemeria brasiliensis), anemone (e.g., Anemone blanda), columbine (Aquilegia sp.), aralia (e.g., Aralia chinensis), aster (e.g., Aster carolinianus), bougainvillea (Bougainvillea sp.), camellia (Camellia sp.), bellflower (Campanula sp.), cockscomb (celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae.

Some herbs, as described herein, are also contemplated.

Any commercially available cultivars, hybrids and new developed cultivars of any of the above-mentioned plants are also contemplated.

In one embodiment, delaying senescence of a cut flower, encompasses, or is manifested by, prolonging flower vase life and/or to maintaining good petal color.

In some of any of the embodiments of the methods as described herein, the stem of a cut flower is dipped or loaded into the composition of the invention. In other embodiments, the cut flower is sprayed with the composition of the invention.

When the composition is contacted with a cut plant as described herein, contacting can be effected immediately after the plant is harvested or cut, or within several days after harvesting or cutting.

In some of any of the embodiments described herein for the methods utilizing a composition as described herein, contacting the plant (e.g., the plant's stem) with a composition as described herein can be effected for a time period that ranges from about 4 hours to about 24 hours, or from about 12 hours to about 24 hours.

As shown in the Examples section that follows, the activity of the CPAS is maintained in a plant upon contacting the plant or a part thereof with the composition as described herein, for at least 12 hours, 24 hours, 48 hours, 72 hours or more.

A composition according to any of the embodiments of the present invention can be produced in any conventional manner, for example, by mixing a CPAS as described herein with a carbonate buffer or any other bicarbonate-containing solution, as described herein, and optionally with an acceptable additive, if present. Mixing is performed while using appropriate amounts of the CPAS and the bicarbonate-containing solution, so as to achieve the desired concentrations and/or pH values, as described herein.

The aqueous solution of the bicarbonate or the carbonate buffer can include water per se, or a mixture of water and other ingredients (organic or inorganic substances or solvents), as long as the amount of water is at least 50% or at least 80% by weight.

The water in the aqueous solution can be tap water, distilled water (including DDW), or deionized (DI) water.

When mixing CPAS with a carbonate buffer (e.g., Na₂CO₃/NaHCO₃ buffer), distilled water or DI water is preferred for preparing the buffer to prevent the formation and precipitation of CaCO₃. When mixing CPAS with a bicarbonate solution (e.g., NaHCO₃ solution), tap water is suitable. However, distilled water or DI water is also preferred as heavy metals present in tap water may affect the efficacy of CPAS.

The composition of the present invention is prepared in any conventional formulations, for example, ready-to-use solutions, suspensions, or emulsions, concentrates, granules, pastes or powders.

In one embodiment, CPAS, carbonate buffer or bicarbonate solution, and optionally one or more acceptable additive, as described herein, are formulated as a concentrate in a customary manner. The aqueous composition as described herein can then be prepared by diluting the concentrate with water, (e.g., distilled water or DI water, as described herein), prior to application.

In one embodiment, CPAS, carbonate buffer or bicarbonate solution, and optionally one or more acceptable additive, as described herein, are formulated as pastes, granules or powders in a customary manner. The composition as described herein can then be prepared by dissolving or dispersing the pastes, granules or powders in water, (e.g., distilled water or DI water), prior to application.

Accordingly, according to an aspect of some embodiments of the present invention, there are provided kits for preparing or using any of the compositions described herein.

In some embodiments, the kit comprises a composition as described herein, in a ready-to-use form. Such a kit may comprise the composition in a container, and may further comprise instructions to apply the composition to at least a part of a plant (e.g., a cut plant) as described herein (e.g., for effecting any of the methods as described herein).

In some embodiments, the kit comprises the CPAS and the bicarbonate-containing solutions packaged individually within the kit, and optionally an additive as described herein, and may further comprise instructions how to mix the ingredients prior to use.

In some embodiments, the kit comprises a concentrate as described herein and may further comprise instructions to mix the concentrate with water or any other aqueous solution. Optionally, the kit comprises also the water or aqueous solution.

In some embodiments, the kit comprises a composition as described herein formulated as pastes, granules or powders, as described herein, and may further comprise instructions how to prepare the composition. Optionally, the kit comprises also the water or aqueous solution.

In some embodiments, the kit comprises the CPAS as described herein (e.g., in a dry form), per se, or optionally with an additive as described herein, and further comprises instructions to mix the CPAS with a bicarbonate-containing solution and optionally with an additive, as described herein, so as to prepare a composition as described herein.

In some embodiments, any of the kits described herein is identified for use in any of the methods as described herein.

In some embodiments, any of the kits as described herein comprises the composition, concentrate, formulation, CPAS, or any other ingredients thereof, packaged in a packaging material.

In some of these embodiments, the kit is identified in print, in or on the packaging material, for use in any of the methods described herein.

In some of these embodiments, the kit further comprises instructions how to use the composition in any of the methods as described herein (e.g., to dip or immerse a cur plant is a composition once prepared, for an indicated time period).

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Materials and Experimental Methods

Synthesis of CPAS and Salts Thereof:

Water-soluble CPAS was prepared according to the procedure described in WO 2011/086561, which is generally effected by:

(i) reacting a compound of formula (III)

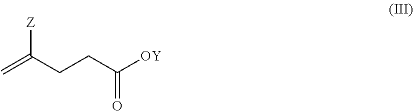

with a haloform of formula CHX₃ to obtain a 3-(1,1,2-trihalocyclopropyl)-propionate compound of formula (II)

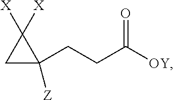

wherein Z and X are independently a halogen and Y is a carboxylic acid protecting group;

(ii) removing the protecting group Y from the compound of formula II to obtain 3-(1,1,2-trihalocyclopropyl)-propionic acid

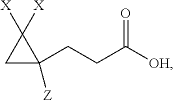

or a salt thereof; and

(iii) reacting 3-(1,1,2-trihalocyclopropyl)-propionic acid obtain in step (ii) with an alkyl lithium to obtain 3-(1-cyclopropyl)-propionic acid; and

(iv) converting 3-(1-cyclopropyl)-propionic acid (CPA) to its salt (CPAS).

It is to be noted that converting the CPA to a salt thereof, as described herein, is effected by methods well known in the art, and can be effected also during the dehalogenation step (iii).

It is to be further noted that CPASs prepared by any other synthetic method are also contemplated.

Activity Assays:

The ethylene antagonizing effect of composition described herein can be assessed by its effect of delaying senescence of cut plants, such as cut flowers. Some embodiments of the present invention are based on the use of the composition described herein to treat cut flowers for delaying senescence of the cut flowers.

Cut Flowers: Unless otherwise noted, carnation flowers grown in a greenhouse were harvested at the beginning of flower opening stage, early in the morning, and were immediately brought to the laboratory. The flowers were either processed immediately or stored in a cold room (4° C.) for 1 to 5 days as required.

Treatment Procedure: The flower stems were cut under tap water to the desired lengths (15 cm-55 cm). Four flowers for each treatment group (of two flowers per each groups) were loaded in a 20 mL aqueous treatment solution (or “loading solution”) for 24 hours. The treatment solution was placed in a 35 mL tube. The loading solutions of CPAS in buffers were prepared in distilled water, as described hereinafter. At the end of CPAS loading, the flowers were transferred to tap water for 1 to 4 days until the cut flowers open. The cut flowers were then exposed to 2 ppm ethylene for 24 hours. Control cut flowers were loaded in a control solution without CPAS in the same manner as the treated cut flowers, and were thereafter exposed to ethylene or air. At the end of ethylene exposure, the flowers were ventilated and left in tap water under controlled conditions (a temperature of 22° C., a relative humidity of 80%, and continuous fluorescent light) for additional 5 days for senescence assessment.

Flower Diameter: In some experiments, flower diameter was determined according to the method described in Goren et al., Plant Growth Regulation 65:327-334 (2011), to assess flower quality.

Water Uptake: The uptake of water by cut flowers was measured after CPAS loading and after ethylene exposure (exposure to 2 ppm ethylene for 24 hours, unless otherwise indicated). The aqueous treatment solution was maintained at 20 mL by addition of tap water after each treatment.

### Example 1

### CPAS in Buffers Having High pH Values

Aqueous treatment solutions of CPAS (sodium salt), at a concentration of 20 ppm to 160 ppm in three different buffer solutions having pH greater than 8.0 were prepared and tested:

1. Na₂CO₃/NaHCO₃, 20 mM, pH 9.4;

2. Glycine/NaOH, 20 mM, pH 8.8; and

3. H₃BO₃/NaOH, 20 mM, pH 9.2.

Cut flowers (36 cm long stems) were treated with the three solutions according to the treatment procedure described above. The cut flowers treated with the aqueous solution of CPAS in Na₂CO₃/NaHCO₃ buffer showed delayed senescence, whereas no effect was shown from cut flowers treated with the aqueous solution of CPAS in Glycine/NaOH buffer solution or H₃BO₃/NaOH buffer solution. These results indicate the ethylene antagonizing effect of CPAS depends upon the type of the buffer used.

### Example 2

### CPAS in Different Carriers

Aqueous treatment solutions of CPAS (sodium salt) in Na-phosphate buffer (20 mM, pH 7.6), NaHCO₃ (20 mM, pH 8.2), and Na₂CO₃/NaHCO₃ buffer (20 mM, pH 9.2-9.4) were prepared and tested as described hereinabove. The cut flowers were treated with the aqueous solutions according to the treatment procedure described above. The test results are summarized in Table 1 below.

TABLE 1
The effect of different carriers on the
ethylene antagonizing effect of CPAS^{a}.

| Solutions | Concentration | pH | Results |
|---|---|---|---|
| Na-Phosphate buffer | 20 mM | 7.6 | − |
| NaHCO₃ | 20 mM | 8.2 | +++ |
| Na₂CO₃/NaHCO₃ buffer | 20 mM | 9.2-9.4 | ++++ |

^{a}The CPAS tested is a sodium salt at a concentration ranging from 20 to 120 ppm.
b. The result “−” means no ethylene antagonizing effect by visual inspection.
c. The result “+++” means high ethylene antagonizing effect by visual inspection.
d. The result “++++” means very high ethylene antagonizing effect by visual inspection.

As shown in Table 1, Na-phosphate buffer has no effect on CPAS for antagonizing ethylene action. However, the carbonate buffer and NaHCO₃ of the present invention enhanced the effect of CPAS for antagonizing ethylene action.

### Example 3

### CPAS in Na₂CO₃/NaHCO₃ Buffer or in NaHCO₃

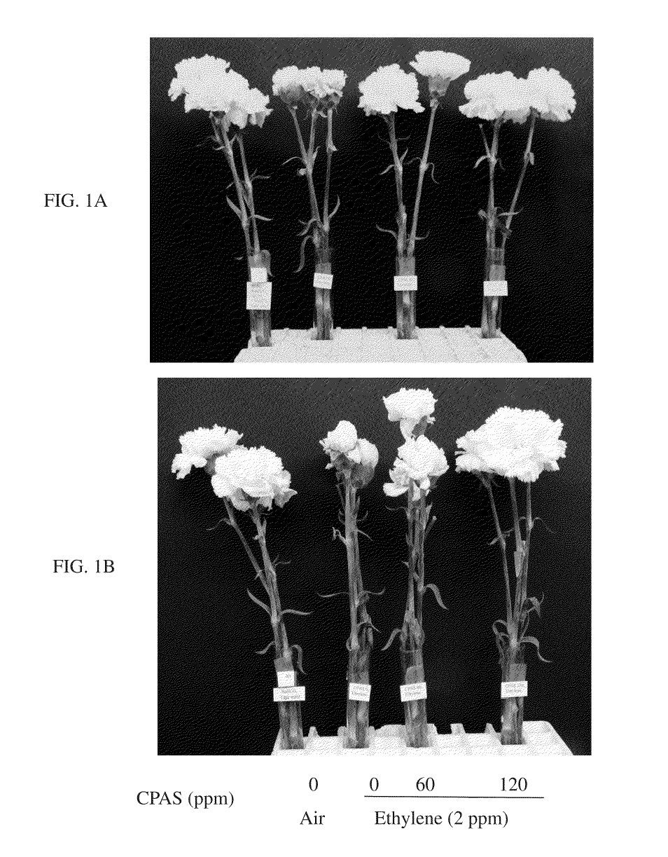

Aqueous treatment solutions of CPAS (sodium salt) were prepared and tested, each of which contained 0, 60 or 120 ppm of CPAS in 20 mM Na₂CO₃/NaHCO₃ buffer (pH 9.4), or in a 20 mM NaHCO₃ solution (pH 8.2). Cut flowers (36 cm long stems) were treated according to the treatment procedure described above. FIGS. 1A-B present photographs of the tested cut flowers. As shown in FIG. 1, CPAS in Na₂CO₃/NaHCO₃ buffer delayed flower senescence at a concentration of 60 or 120 ppm CPASCPAS in NaHCO₃ delayed flower senescence at 120 ppm CPAS.

### Example 4

### Water Uptake of Treated Cut Flowers

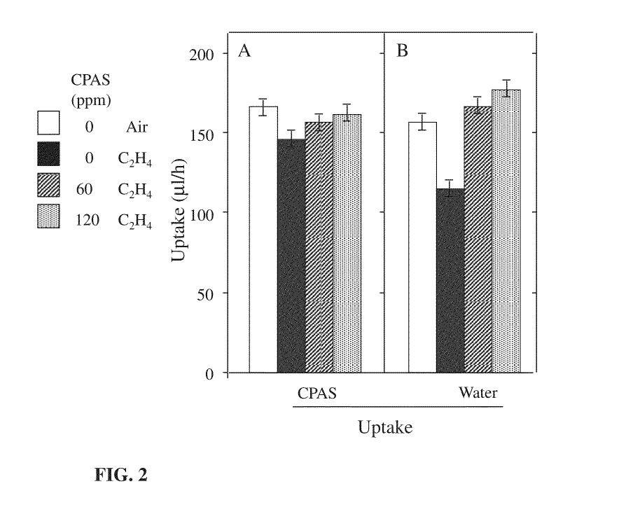

The vitality of the cut flowers treated with the CPAS compositions according to the present invention can be expressed in the amount of water uptake of flowers during the first 48 hours after the termination of ethylene exposure. An increased water uptake indicates greater vitality. Aqueous treatment solutions of CPAS were prepared and tested, each of which contained 0, 60 or 120 ppm of CPAS in 20 mM NaHCO₃ (pH 8.2). Cut flowers (36 cm long stems) were treated according to the treatment procedure described above. The obtained data is presented in FIG. 2. As shown in FIG. 2, CPAS in NaHCO₃ increased water uptake of flowers 48 hours after the termination of ethylene exposure (2 ppm of ethylene for 24 hours).

It was found that each cut flower took up from about 3.6 to about 4.3 mL of water during 48 hours after the termination of ethylene exposure. Based on these data, approximately 3.2 to 5.2 μg CPAS per flower will be an effective amount of CPAS for obtaining maximum efficacy.

### Example 5

### Different Stem Lengths of Cut Flowers

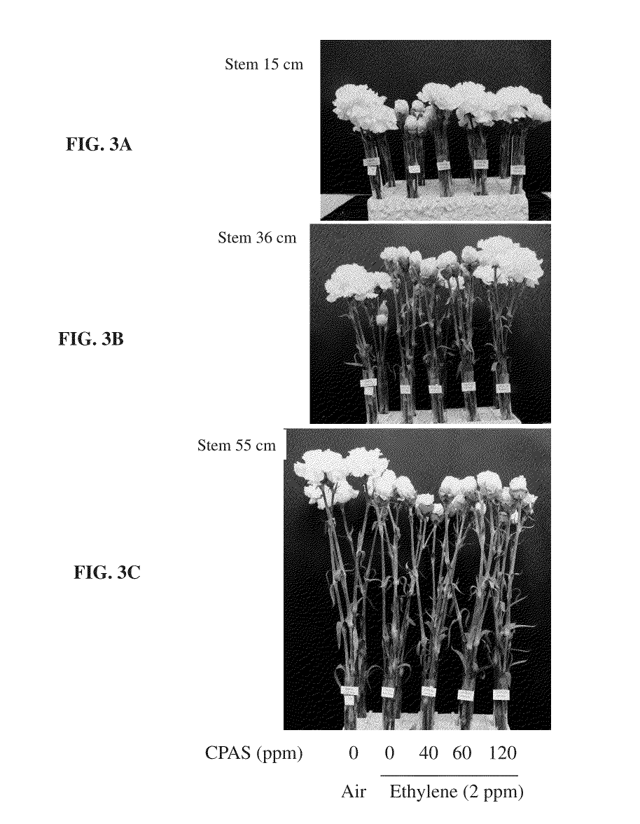

Cut flowers having stem lengths of 15, 36, or 55 cm, respectively, were treated with aqueous treatment solutions containing various concentrations (0, 40, 60 and 120 ppm) CPAS (sodium salt) in 20 mM NaHCO₃ (pH 8.2) according to the treatment procedure described above. Photographs presenting the cut flowers following treatment are shown in FIG. 3, and demonstrate that the efficacy of the solution decreased as the length of the flowers increased. Cut flowers having stem length of 15 cm showed delayed senescence at 40, 60 and 120 ppm CPAS, whereas cut flowers having stem length of 36 cm showed delayed senescence at 120 mM CPAS. No delayed senescence was observed in cut flowers having stem length of 55 cm at 120 mM CPAS.

### Example 6

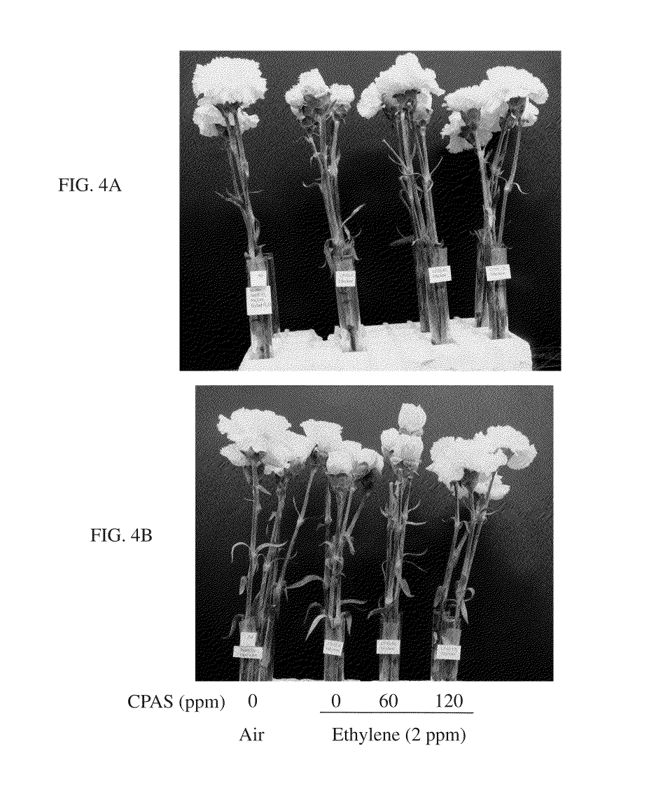

Effect of Concentration of Na₂CO₃/NaHCO₃ Buffer or NaHCO₃Cut flowers having stem length of 55 cm were treated with aqueous treatment solutions containing 0, 60 or 120 ppm CPAS (sodium salt) in 60 mM Na₂CO₃/NaHCO₃ buffer (pH 9.4), or in 60 mM NaHCO₃ (pH 8.2), according to the treatment procedure described above. FIG. 4 presents photographs of the treated cut flowers and shows a delayed senescence at 120 ppm CPAS. These results indicate that increasing the concentration of NaHCO₃ from 20 mM (as described in EXAMPLE 5) to 60 mM, cut flowers showed delayed senescence at 120 ppm CPAS. Additionally, cut flowers showed delayed senescence after the treatment with CPAS in 60 mM Na₂CO₃/NaHCO₃ buffer, at 60 or 120 ppm CPAS.

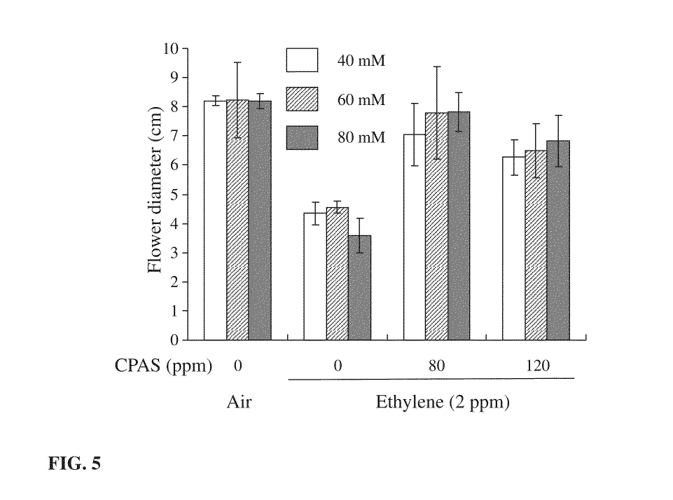

In an additional test, aqueous treatment solutions of 80 or 120 ppm CPAS in 40, 60 or 80 mM Na₂CO₃/NaHCO₃ buffer were prepared and tested. Cut flowers having stem length of 55 cm were treated according to the treatment procedure described above. FIG. 5 presents the effect of the treatment of solutions tested, as measured by flower diameter, and shows delayed senescence of cut flowers at all concentrations of Na₂CO₃/NaHCO₃ buffer and of CPAS tested.

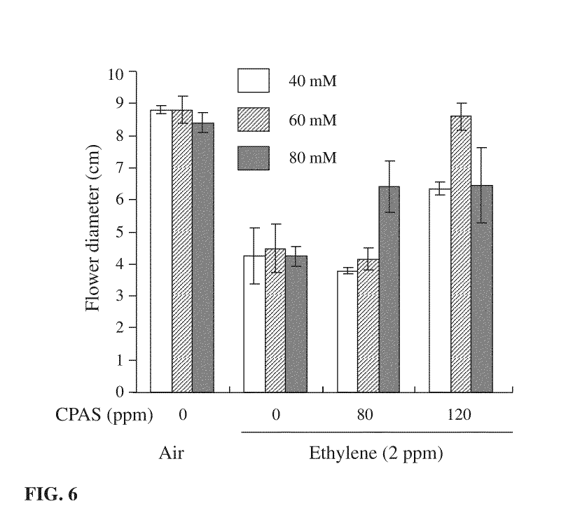

In a further test, aqueous treatment solutions of 80 or 120 ppm CPAS in 40, 60 or 80 mM NaHCO₃ were prepared and tested. Cut flowers having stem length of 55 cm were treated according to the treatment procedure described above. FIG. 6 presents the effect of the treatment of solutions tested, as measured by flower diameter. As shown in FIG. 6, delayed senescence of cut flowers was observed when cut flowers were treated with 80 ppm CPAS in 80 mM NaHCO₃. As further shown in FIG. 6, delayed senescence of cut flowers was observed when cut flowers were treated with 120 ppm CPAS in 40, 60 or 80 mM NaHCO₃, among which 60 mM NaHCO₃ demonstrated the highest ethylene antagonizing effect.

### Example 7

### CPAS in Na-Phosphate Buffer Containing NaHCO₃

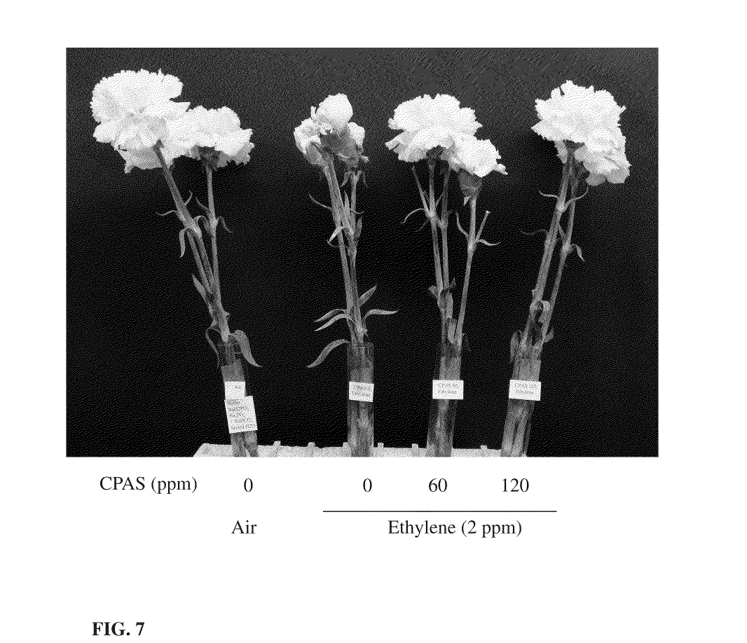

A Na-phosphate buffer/NaHCO₃ solution (pH 7.2) was prepared by adding NaHCO₃ (60 mM, pH 8.2) to a Na-phosphate buffer (20 mM, pH 6.0). Cut flowers (36 cm long stems) were treated with aqueous treatment solutions of 60 or 120 ppm CPAS (sodium salt) in the Na-phosphate buffer containing NaHCO₃ according to the treatment procedure described above. FIG. 7 presents photographs of the treated cur flowers and shows delayed senescence of cut flowers treated with CPAS at 60 and 120 ppm concentration.

### Example 8

### CPAS in Na-Phosphate or Na-Phosphate/Citrate buffers Containing NaHCO₃

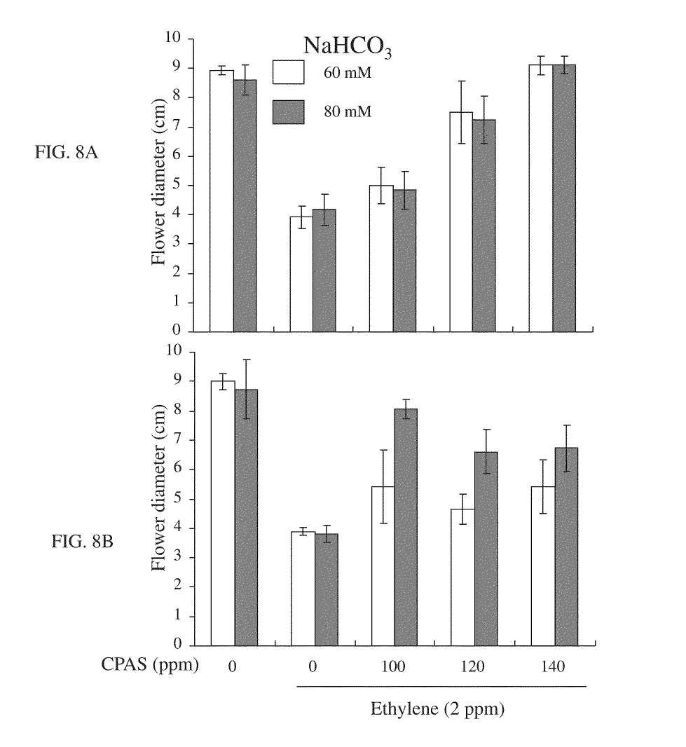

A Na-phosphate buffer containing NaHCO₃ (pH 7.2) was prepared as described in EXAMPLE 7. A Na-phosphate/citrate buffer containing NaHCO₃ (pH 7.4) was prepared by adding NaHCO₃ to a Na-phosphate/citrate buffer (20 mM, pH 6.0). Cut flowers (55 cm long stems) were treated with aqueous treatment solutions of 100, 120 or 140 ppm CPAS (sodium salt) in the Na-phosphate buffer containing NaHCO₃ or Na-phosphate/citrate buffer containing NaHCO₃ according to the treatment procedure described above. The obtained data is presented in FIGS. 8A-B, as the measured flower diameter. As shown therein, delayed senescence was generally observed for cut flowers treated with CPAS aqueous solutions. As shown in FIG. 8A, the concentration of NaHCO₃ (60 or 80 mM) in the Na-phosphate buffer containing NaHCO₃ did not significantly affect the treatment results. As shown in FIG. 8B, the concentration of NaHCO₃ (60 or 80 mM) in the Na-phosphate/citrate buffer containing NaHCO₃ affected the treatment results, with 80 mM NaHCO₃ yielding better treatment results than 60 mM NaHCO₃.

### Example 9

### CPAS in Different Solutions

Carnation cut flowers having 36-55 cm long stems were treated with aqueous treatment solutions of 20-120 ppm CPAS (sodium salt) in various solutions/buffers according to the treatment procedure described above.

The obtained data is summarized in Table 2 below.

TABLE 2
The effect of different buffer, salts and additives on the efficacy of CPAS^{a}.

| Buffers/Solutions | Concentration | | pH | Additives | Results |
|---|---|---|---|---|---|
| K-Citrate/Citric | 20 | mM | 4.65 | | − |
| Ac. buffer | | | | | |
| K-Citrate/Citric | 20 | mM | 5.0 | PVP (0.5%)^{b} | − |
| Ac. buffer | | | | | |
| K-Citrate/Citric | 20 | mM | 5.0 | EMK (5%)^{c} | − |
| Ac. buffer | | | | | |
| K-Citrate/Citric | 20 | mM | 5.0 | 2,3-butanedione | − |
| Ac. buffer | | | | (500 ppm) | |
| Isopropylamine | 500-1000 | ppm | 11.0 | | − |
| HCl-TRIS buffer | 20 | mM | 8.4 | | − |
| Glycine/NaOH buffer | 20 | mM | 8.8 | | − |
| Na₂B₄O₇/NaOH buffer | 20 | mM | 9.4 | | − |
| H₃BO₃/NaOH buffer | 20 | mM | 9.2 | | − |
| Na-Phosphate buffer | 20 | mM | 7.6 | | − |
| EDTA | 500-1000 | ppm | | | + |
| KHCO₃ | 20-80 | mM | 8.2 | | ++ |
| NaHCO₃ | 20-80 | mM | 8.2 | | +++ |
| NaHCO₃ | 40 | mM | 8.2 | Chloramphenicol | +++ |
| | | | | 50 μM | |
| Na₂CO₃/NaHCO₃ buffer | 20-80 | mM | 9.2-9.4 | | ++++ |
| Na₂CO₃/NaHCO₃ buffer | 40 | mM | 9.2-9.4 | Chloramphenicol | ++++ |
| | | | | 150 μM | |
| Na-Phosphate | 20 | mM | 6.0 | | +++ |
| buffer + NaHCO₃ | 60-80 | mM | 7.4 | | |
| Na-Phosphate/Citrate | 20 | mM | 6.0 | | +++ |
| buffer + NaHCO₃ | 60-80 | mM | 7.2 | | |

^{a}The CPAS is a sodium salt at a concentration ranging from 20 to 120 ppm.
^{b}“PVP” is polyvinylpyrrolidone.
^{c}“EMK” is ethyl methyl ketone.
d. The result “−” means no ethylene antagonizing effect by visual inspection.
e. The result “+” means low ethylene antagonizing effect by visual inspection.
f. The result “++” means medium ethylene antagonizing effect by visual inspection.
g. The result “+++” means high ethylene antagonizing effect by visual inspection.
h. The result “++++” means very high ethylene antagonizing effect by visual inspection.

The obtained data clearly demonstrate the advantageous effect of using carbonate or bicarbonate-containing solutions in antagonizing ethylene response.

### Example 10

### Spraying with CPAS in Na₂CO₃/NaHCO₃ Buffer

Carnation flowers were harvested at the full bloom stage, when the outer petals deflected at right angles to the stem. The flowers were selected for uniformity in terms of flower diameter and placed in tap water. The flowers were then sprayed with various concentrations of the CPAS (sodium salt) ranging from 40 to 120 ppm dissolved in Na₂CO₃/NaHCO₃ buffer (pH 9.2, 20 to 60 mM) in deionized water. The deionized water was used to avoid salt precipitation due to the existence of calcium in tap water. The treatment solution contained a surfactant, Triton-X 100™ (0.05%). Twenty-four hours after the spraying application, the flowers were treated with 2 ppm ethylene for 24 hours. During treatment and during observation of vase-life, the flowers were kept at 22° C. Each treatment was carried out in three replicates, 3 flowers in each replicate.

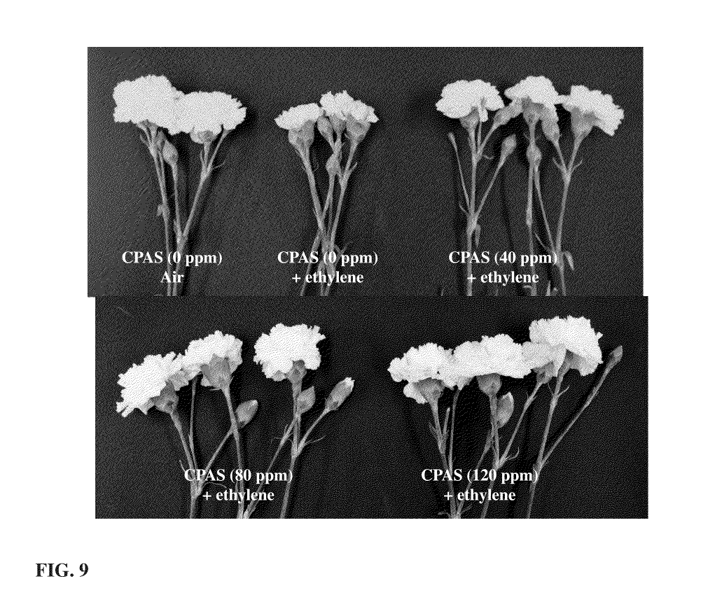

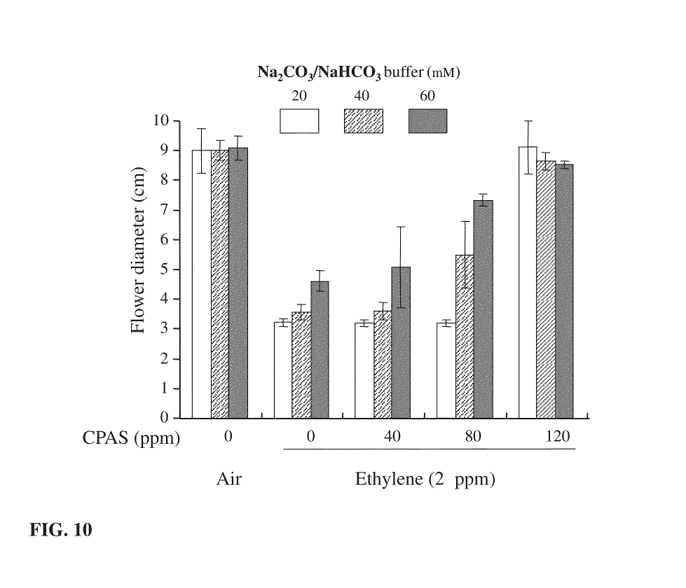

The obtained results are presented in FIGS. 9 and 10, and show that at a lower CPAS concentration (40 ppm) and a lower buffer concentration (below 60 mM), CPAS had little effect on ethylene-induced flower senescence, but had effect in antagonizing ethylene-induced flower senescence at a higher buffer concentration (above 60 mM). At a higher CPAS concentration (80 and 120 ppm, respectively), CPAS had a significant effect in antagonizing ethylene-induced flower senescence, at a low or a high buffer concentration (40 and 60 mM).

### Example 11

### Spraying with CPAS in NaHCO₃ Solution

Carnation flowers were harvested at the full bloom stage, when the outer petals deflected at right angles to the stem. The flowers were selected for uniformity in terms of flower diameter and placed in tap water. The flowers were then sprayed with various concentrations of CPAS (sodium salt) ranging from 15 to 60 ppm dissolved in NaHCO₃ (pH 8.2, 20 and 40 mM) in tap water. The treatment solution contained a surfactant, Kinetic® (0.05%). Twenty-four hours after the CPAS spraying application, the flowers were treated with 2 ppm ethylene for 24 hours. During treatment and during observation of vase-life, the flowers were kept 22° C. Each treatment was carried out in three replicates, 3 flowers in each replicate.

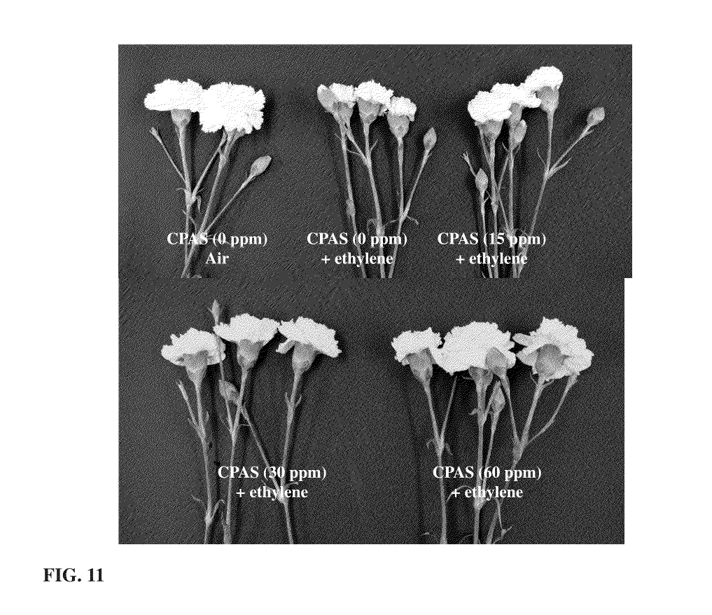

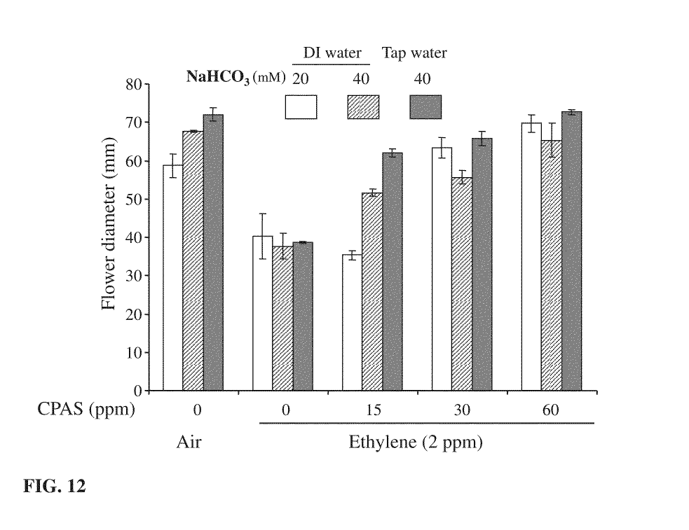

The obtained results are presented in FIGS. 11 and 12, and show that at the lowest CPAS concentration (15 ppm), CPAS had little effect on ethylene-induced flower senescence. However, at the higher CPAS concentrations, CPAS significantly delayed flower senescence. Flowers treated with CPAS in NaHCO₃ (40 mM), dissolved in tap water, delayed flower senescence more efficiently than when dissolved in DI water.

### Example 12

### Treatment Procedure

Carnation flower stems were cut under tap water to the desired lengths (36 and 55 cm). Four flowers per treatment, in groups of two flowers each, were loaded for 14-18 hours in 20 mL of treatment solutions containing 0, 30, 60 and 120 mg L⁻¹ CPAS in either an aqueous solution containing sodium carbonate/sodium bicarbonate buffer (40 mM, pH=9.5) and 0.025% Tween 20 or an aqueous solution containing K-Phosphate Buffer (40 mM, pH=7.8) and 0.025% Tween 20. At the end of CPAS loading (14-18 hours), groups of treated flowers were transferred into tap water for 0, 24, 48 and 72 hours. The cut flowers were then exposed to 1.0 ppm ethylene for 24 hours. At the end of the ethylene treatment, the flowers were ventilated and left under controlled conditions for additional 11, 10, 9, 8 days, respectively, for vase life assessment. Pictures of were taken 13 days after beginning of the experiment. It is noted that the carnation flowers tested were highly sensitive to ethylene, and therefore exposure to ethylene at an amount of 1.0 ppm was effected.

Results:

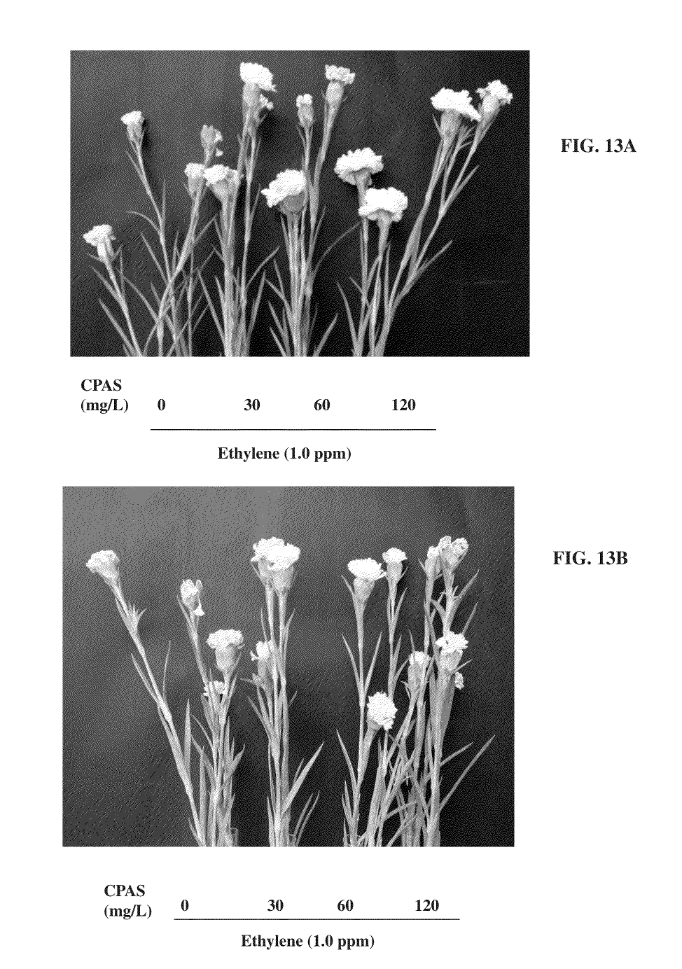

FIGS. 13A-B present the data obtained for the following treatment procedure:

CPAS (14-18 h)→air (0 h)→Ethylene (1.5 ppm, 24 h)→air (11 days)

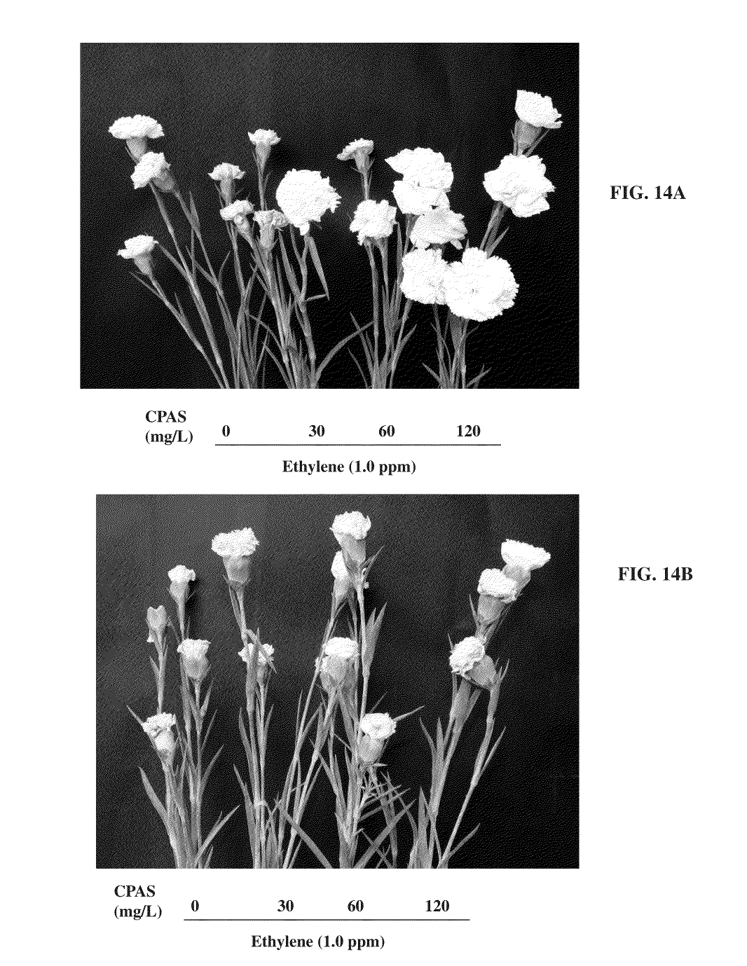

FIGS. 14A-B present the data obtained for the following treatment procedure:

CPAS (14-18 h)→air (24 h)→Ethylene (1.5 ppm, 24 h)→air (11 days)

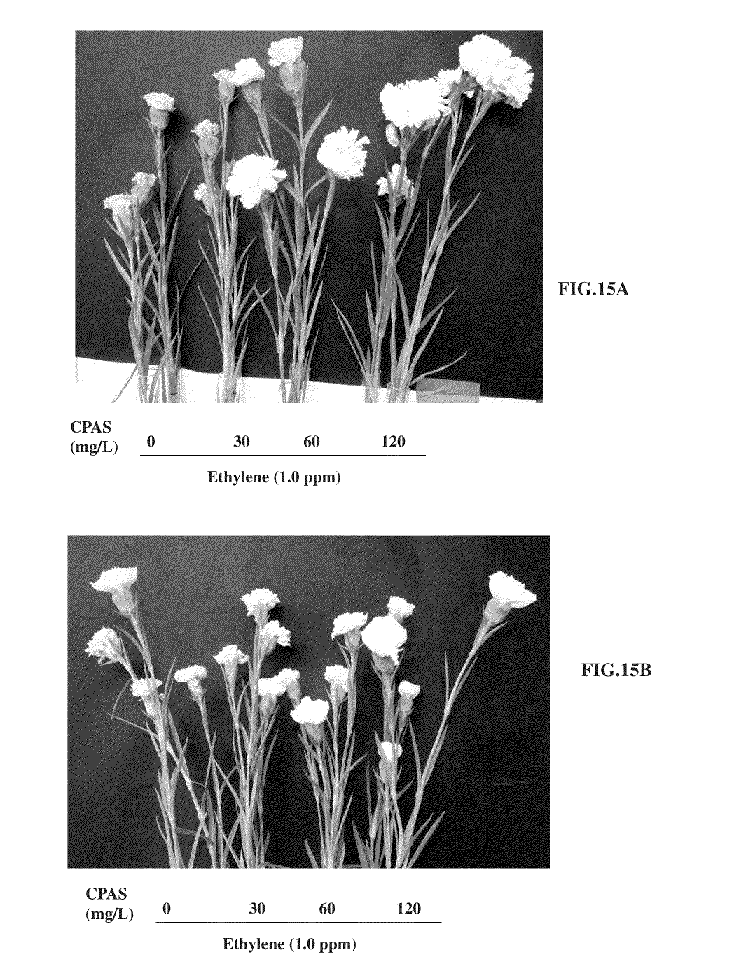

FIGS. 15A-B present the data obtained for the following treatment procedure:

CPAS (14-18 h)→air (48 h)→Ethylene (1.5 ppm, 24 h)→air (11 days)

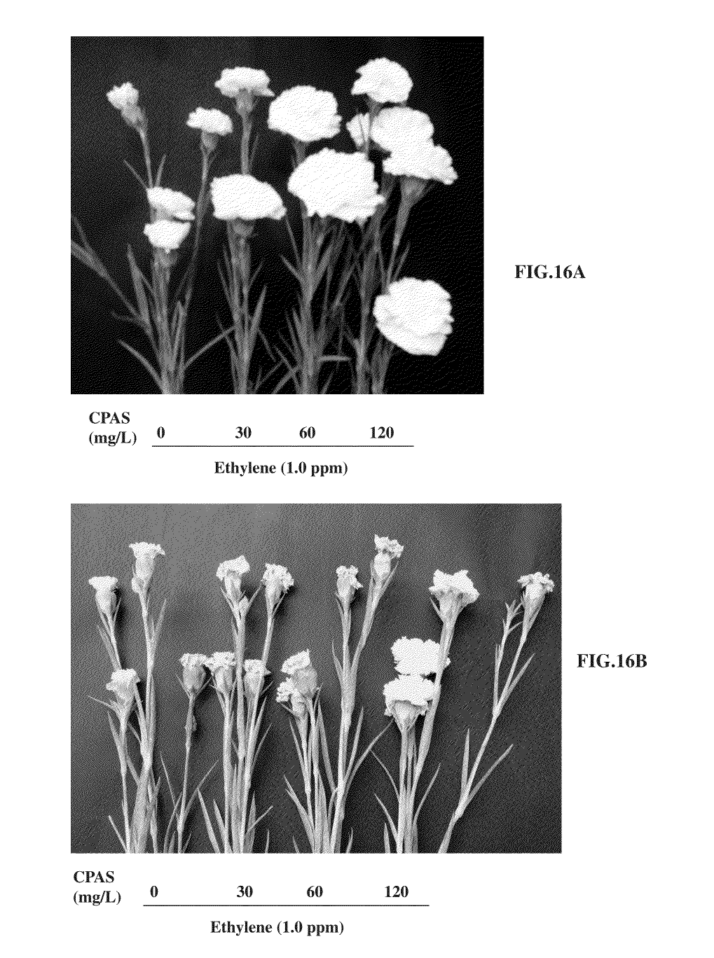

FIGS. 16A-B present the data obtained for the following treatment procedure:

CPAS (14-18 h)→air (72 h)→Ethylene (1.5 ppm, 24 h)→air (11 days)

As shown in FIGS. 13-16, loading carnation flowers with CPAS (60 and 120 mg L⁻¹) dissolved in carbonate buffer significantly protected the flowers from ethylene-induced senescence, while almost no protection from ethylene-induced senescence was observed with flowers loading with CPAS (60 and 120 mg L⁻¹) dissolved in K-Phosphate buffer. Treated flowers with CPAS at the two higher concentrations dissolved in Na-Carbonate buffer followed by ethylene treated 2 and 3 days after the pretreatment with the inhibitor, were more protected as the incubation time increases (FIGS. 15A and 16A). Carnation flowers pretreated with CPAS are resistant to ethylene-induced flower senescence even 3 days after the pretreatment with the inhibitor. This indicates that CPAS is stable at least 3 days after treatment.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising a water-soluble salt of 3-(1-cyclopropenyl)propanoic acid of formula (I): 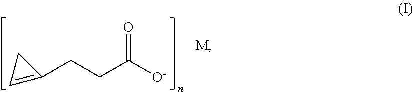
wherein:
n is 1 or 2; and
M is a monovalent or divalent cation, respectively
and
a bicarbonate-containing aqueous solution.

2-3. (canceled)

4. The composition according to claim 1, wherein n is 1, and M is sodium ion.

5-6. (canceled)

7. The composition according to claim 1, wherein the bicarbonate solution comprises NaHCO₃.

8. The composition according to claim 7, wherein the bicarbonate solution further comprises sodium-containing buffer.

9. The composition according to claim 8, wherein said buffer is selected from sodium phosphate buffer, sodium citrate buffer and a combination thereof.

10. The composition according to claim 8, wherein an amount of said sodium-containing buffer is such that a pH of the composition is at least 6.5.

11. The composition according to claim 1, wherein the bicarbonate-containing solution comprises a carbonate/bicarbonate buffer.

12. (canceled)

13. The composition according to claim 11, wherein a pH of said buffer is higher than 9.0.

14. The composition according to claim 1, wherein a pH of said bicarbonate-containing solution is higher than 7.0.

15. (canceled)

16. The composition according to claim 1, wherein a concentration of the water soluble salt of 3-(1-cyclopropenyl)propanoic acid ranges from about 10 ppm to about 200 ppm.

17-18. (canceled)

19. The composition according to claim 1, comprising from about 20 to about 160 ppm of the water-soluble salt of 3-(1-cyclopropenyl)propanoic acid of formula (I); an aqueous solution comprising a bicarbonate in a concentration of from about 20 mM to about 160 mM; and water.

20. (canceled)

21. The composition according to claim 19, wherein said bicarbonate-containing solution comprises a carbonate/bicarbonate buffer.

22. The composition according to claim 19, wherein said bicarbonate-containing solution comprises sodium bicarbonate.

23. The composition according to claim 22, wherein said bicarbonate-containing solution further comprises sodium phosphate, or a combination of sodium phosphate and sodium citrate buffers in a concentration of from about 10 mM to about 80 mM.

24. The composition according to claim 1, further comprising an acceptable additive selected from the group consisting of a surfactant, a bactericide, a disinfectant, and a combination thereof.

25. A method of antagonizing ethylene response in a plant, the method comprising contacting at least a part of the plant with the composition according to claim 1.

26-27. (canceled)

28. The method according to claim 25, wherein said contacting is carried out after the plant is picked, cut or harvested.

29. (canceled)

30. A method of delaying senescence of a cut plant, the method comprising contacting at least a part of the cut plant with the composition according to claim 1.

31. The method according to claim 30, wherein the cut plant is a cut flower.

32. (canceled)

33. The method according to claim 30, wherein said contacting is carried out by loading or spraying.

34. (canceled)

35. A kit for forming and/or using the composition according to claim 1, the kit comprising the water soluble salt of 3-(1-cyclopropenyl)propanoic acid, and the bicarbonate-containing solution.

36. The kit of claim 35, wherein the water soluble salt of 3-(1-cyclopropenyl)propanoic acid and the bicarbonate-containing solution are packaged individually within the kit.

37. The kit according to claim 36, wherein the water soluble salt of 3-(1-cyclopropenyl)propanoic acid is in a dry form.

38. (canceled)

39. The kit according to claim 36, wherein the water soluble salt of 3-(1-cyclopropenyl)propanoic acid is dissolved is an aqueous carrier.

40. The kit according to claim 39, comprising a concentrated solution of the water soluble salt of 3-(1-cyclopropenyl)propanoic acid.

41. The kit according to claim 35, wherein the water soluble salt of 3-(1-cyclopropenyl)propanoic acid and the bicarbonate-containing solution are packaged together within the kit, in a form of a concentrate or a paste.

42. The kit according to claim 41, further comprising an aqueous carrier.

43. (canceled)

44. The kit according to claim 35, identified for use in antagonizing ethylene response in a plant and/or in delaying senescence of a cut plant.

45. (canceled)
